(19) United States
(12) Patent Application Publication
(10) Pub. No.: US 2015/0029711 A1
(43) Pub. Date: Jan. 29, 2015

(54) STRAIGHT TUBE LIGHT-EMITTING LAMP

(71) Applicant: Yuhki Terao, Kawaski-shi (JP)

(72) Inventor: Yuhki Terao, Kawaski-shi (JP)

(73) Assignee: Pioneer Corporation, Kawasaki-shi, Kanagawa (JP)

(21) Appl. No.: 14/376,606

(22) PCT Filed: Feb. 17, 2012
(86) PCT No.: PCT/JP2012/053830

§ 371 Date: Aug. 4, 2014

(51) Int. Cl. F21V 19/00; F21S 9/02

(52) U.S. Cl. CPC F21V 19/0075; F21S 9/02
USPC 362/223

(57) ABSTRACT

A straight tube light-emitting lamp includes: a pipe-shaped transparent tube; an organic EL tubular illuminant disposed inside the pipe-shaped transparent tube so as to surround a center axis of the pipe-shaped transparent tube; a battery box disposed at an inner side than the tubular illuminant for housing a battery; and a wiring circuit for supplying an output voltage of the battery housed in the battery box to the tubular illuminant.

### TECHNICAL FIELD

The present invention relates to a straight tube light-emitting lamp using an organic electroluminescence (hereinafter referred to as “organic EL”) element.

### BACKGROUND ART

A light-emitting device using an organic EL element as a light emission source has been known. The light-emitting device using an organic EL element produces surface emission and has a feature such that it has no restrictions on its shape. Therefore, the light-emitting device using an organic EL element can be formed as a flat panel and such a feature cannot be obtained by other light-emitting devices such as an LED (Light-Emitting Diode) light-emitting device. Thus, a further future development toward practical use has been anticipated.

A straight tube light-emitting lamp using an organic EL element that can be used as a light emission source in the same manner as a conventional straight tube fluorescent lamp has also been known (see Patent Document 1). This straight tube light-emitting lamp can use a feeding device having the same shape as a feeding device in the conventional straight tube fluorescent lamp. Therefore, the straight tube light-emitting lamp can be easily substituted for the conventional straight tube fluorescent lamp.

### CITATION LIST

### Patent Documents

Patent Document 1: Japanese Patent Application Laid-Open No. 2005-108516

### SUMMARY OF THE INVENTION

### Problem to be Solved by the Invention

However, such a conventional straight tube light-emitting lamp using an organic EL element is configured to emit light by providing an AC-DC converter in the feeding device, employing an AC power supply as a power source, and obtaining a DC voltage from the converter. When the straight tube light-emitting lamp is directly driven with a DC power supply such as a battery, a power circuit and a housing are separately needed.

In light of this, one example of a problem to be solved by the invention is the above-described drawback. It is an object of the present invention to provide a straight tube light-emitting lamp using an organic EL element that can be used in a conventional fluorescent lamp lighting apparatus and can also employ DC direct drive using a DC power supply.

### Means to Solve the Problem

A straight tube light-emitting lamp according to an invention of claim 1 includes: a pipe-shaped transparent tube; an organic EL tubular illuminant disposed inside the pipe-shaped transparent tube so as to surround a center axis of the pipe-shaped transparent tube; a battery box disposed at an inner side than the tubular illuminant, for housing a battery; and a wiring circuit for supplying an output voltage of the battery housed in the battery box to the tubular illuminant.

### DESCRIPTION OF EMBODIMENTS

In the straight tube light-emitting lamp according to the invention of claim 1, the battery box is provided at the inner side than the tubular illuminant in the pipe-shaped transparent tube. Thus, when DC direct drive is performed by using a battery, a light-emitting portion composed of an organic EL element can be enabled to emit light only by housing the battery in the battery box. Thus, light emission drive by means of a DC power supply is possible without externally providing a DC power supply.

### BRIEF DESCRIPTION OF DRAWINGS

FIG. 1 is a view illustrating an exterior of a straight tube light-emitting lamp according to a first embodiment of the present invention.

FIG. 2 is a view illustrating a transverse section of the light-emitting lamp in FIG. 1 taken along a line A-A.

FIG. 3 is a view illustrating a longitudinal section of the light-emitting lamp in FIG. 1.

FIG. 4 is a view illustrating a longitudinal section of a battery box in the light-emitting lamp in FIG. 1.

FIG. 5 is a circuit diagram illustrating an exemplary electrical circuit in the light-emitting lamp in FIG. 1.

FIG. 6 is a diagram illustrating another exemplary electrical circuit in the light-emitting lamp in FIG. 1.

FIG. 7 is a view illustrating a transverse section of a straight tube light-emitting lamp according to a second embodiment of the present invention corresponding to the A-A portion in FIG. 1.

FIG. 8 is a view illustrating a transverse section of a straight tube light-emitting lamp according to a third embodiment of the present invention corresponding to the A-A portion in FIG. 1.

FIG. 9 is a view illustrating a longitudinal section of a battery box according to a fourth embodiment of the present invention.

FIG. 10 is a circuit diagram illustrating an electrical circuit according to a fifth embodiment of the present invention.

FIG. 11 is a view illustrating a transverse section of a straight tube light-emitting lamp according to a sixth embodiment of the present invention corresponding to the A-A portion in FIG. 1.

FIG. 12 is a view illustrating a transverse section of a straight tube light-emitting lamp in which a heat sink is disposed in a space inside a battery box according to the sixth embodiment of the present invention.

FIG. 13 is a view illustrating a transverse section of a straight tube light-emitting lamp in which a rectifier unit is disposed in a space inside a battery box according to the sixth embodiment of the present invention.

FIG. 14 is a view illustrating a longitudinal section of a battery box which can be used in the sixth embodiment of the present invention.

### EMBODIMENTS

Embodiments of the present invention will be described below in detail with reference to the drawings.

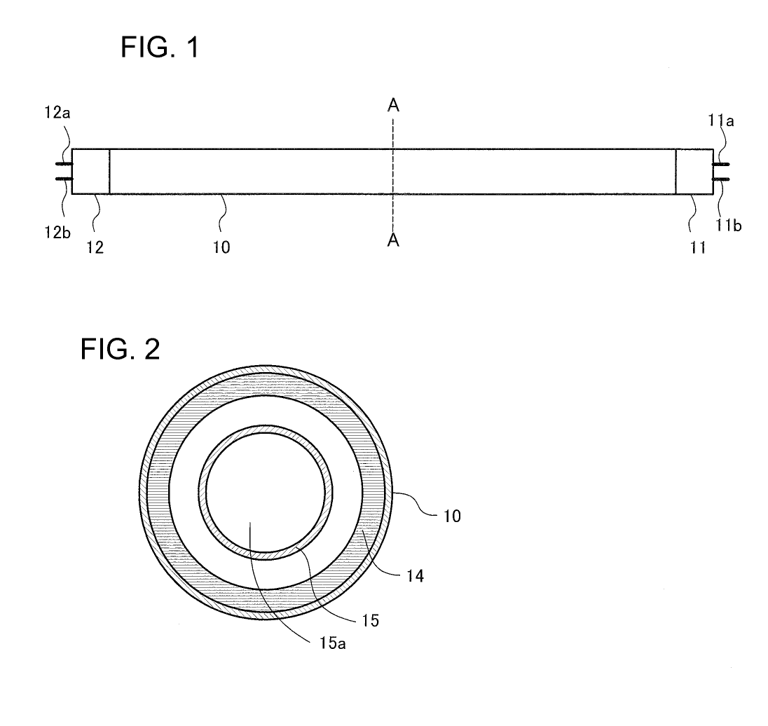

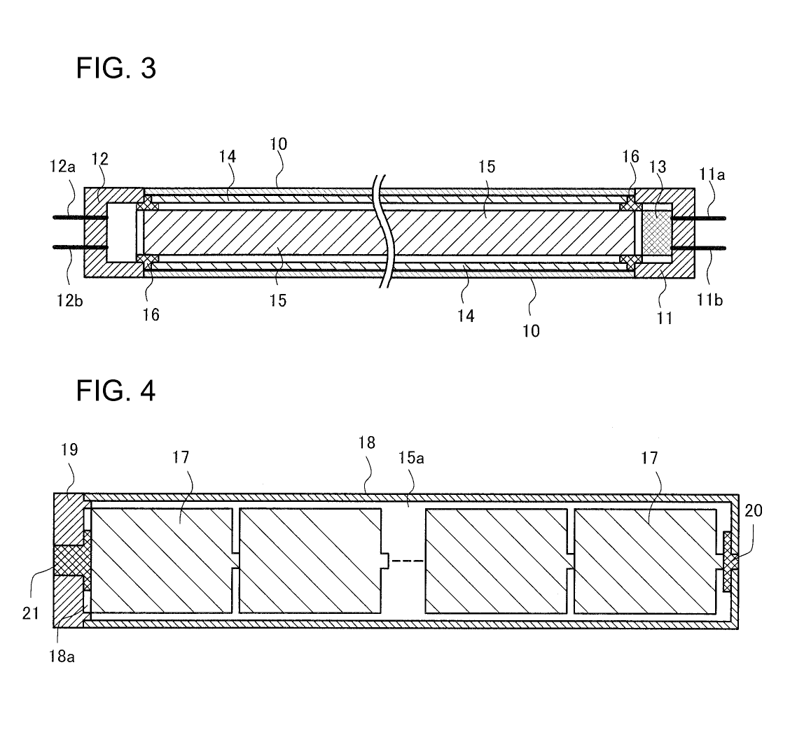

FIG. 1 illustrates an exterior of a straight tube light-emitting lamp according to the first embodiment of the present invention. FIG. 2 illustrates a transverse section of the straight tube light-emitting lamp in FIG. 1. FIG. 3 illustrates a longitudinal section of the straight tube light-emitting lamp in FIG. 1. As illustrated in FIG. 1, this straight tube light-emitting lamp includes: a cylindrical transparent glass tube (including semitransparent) 10 as a pipe-shaped transparent tube; and two bases 11 and 12. Other than a glass, the pipe-shaped transparent tube may be made of a resin such as acrylic. The tubular transparent glass tube 10 has openings at both ends thereof. The bases 11 and 12 are provided for the openings so as to cover the respective openings. The base 11 is fixed to the opening at one end of the cylindrical transparent glass tube 10 and the base 12 is removably engaged with the opening at the other end of the cylindrical transparent glass tube 10. In order to attach the straight tube light-emitting lamp to a fluorescent lamp lighting apparatus, the bases 11 and 12 are configured so as to be couplable to sockets (not shown) of the fluorescent lamp lighting apparatus as with bases in a typical straight tube fluorescent lamp. Specifically, the bases 11 and 12 include two pin terminals 11a and 11b and 12a and 12b, respectively, at opposite sides of the cylindrical transparent glass tube 10. The pin terminals 11a, 11b, 12a, and 12b have shapes corresponding to the sockets of the fluorescent lamp lighting apparatus.

Further, a rectifier unit 13 is housed in at least one (11 in this embodiment) of the two bases 11 and 12. The rectifier unit 13 is provided for performing AC-DC conversion drive of the straight tube light-emitting lamp with the use of an AC power supply. An AC voltage fed through the pin terminals 11a and 11b of the base 11 is converted into a DC voltage.

Inside the cylindrical transparent glass tube 10, a tubular illuminant (organic EL tubular illuminant) 14 composed of an organic EL element is disposed along a tube inner wall so as to surround a center axis of the glass tube 10. For the disposition of the tubular illuminant 14, an organic EL element may be directly formed on the inner wall of the cylindrical transparent glass tube 10 or an organic EL element formed on a flexible substrate may be adhered to the inner wall of the cylindrical transparent glass tube 10, for example.

The organic EL element of the tubular illuminant 14, although not shown in the figure, includes an anode, a light-emitting functional layer, and a cathode. The anode is made of ITO, for example, and formed on the cylindrical transparent glass tube 10 or the above-described flexible substrate. The light-emitting functional layer is formed on the anode. The light-emitting functional layer has a multilayer laminated structure including a hole transport layer, a light-emitting layer, and an electron transport layer in the order from the anode side. The light-emitting functional layer can be formed with a dry method such as a vacuum deposition method. It is also possible to form the light-emitting functional layer with a wet method such as an ink-jet method or printing. As a material for the hole transport layer, NPB can be used. As materials for the light-emitting layer, host CBP and dopant Btp₂Ir(acac) can be used for a red light-emitting layer, host CBP and dopant Ir(ppy)₃ can be used for a green light-emitting layer, and host CBP and dopant FIr(pic) can be used for a blue light-emitting layer. As a material for the electron transfer layer, Alq₃ can be used.

The cathode is formed on the light-emitting functional layer. The cathode can be formed with a vacuum deposition method. As a metal material, a light-reflecting metal such as Al or Ag is used.

Further, in the tubular illuminant 14, a sealing material such as a sealing film is disposed on the cathode in order to seal the organic EL element.

The tubular illuminant 14 may be formed of one organic EL element or constituted by a plurality of organic EL elements.

At an inner side than the tubular illuminant 14 in the cylindrical transparent glass tube 10, i.e., at a center inside the cylindrical transparent glass tube 10, a tubular battery box 15 is disposed so as to surround the center axis of the tubular illuminant 14. There is a space between the tubular illuminant 14 and the battery box 15. The battery box 15 is provided for performing DC direct drive of the straight tube light-emitting lamp without using the rectifier unit 13. The battery box 15 includes a space 15a for housing dry cells to be described later. The battery box 15 is fixed to the cylindrical transparent glass tube 10 by fixing parts 16 provided in opposite end portions of the cylindrical transparent glass tube 10.

As illustrated in FIG. 4, the battery box 15 includes a longitudinal cylindrical case 18 for holding a plurality of (e.g., 10) dry cells 17 connected in series in a direction connecting between both ends of the cylindrical transparent glass tube 10. One end of the case 18 located on the base 12 side is a battery insertion hole 18a. A cap 19 is detachably attached to the battery insertion hole 18a. By removing the cap 19 from the case 18, the dry cells 17 can be removed from the case 18 or inserted into the case 18. A positive terminal 20 is fixed to a bottom portion of the case 18 and a negative terminal 21 is fixed to the cap 19. The positive terminal 20 electrically connects between the inside and outside of the case 18 through the bottom portion. The negative terminal 21 electrically connects between the inside and outside of the case 18 through the cap 19. Thus, if the dry cells 17 are inserted into the case 18 and the cap 19 is attached to the case 18 in order to close the battery insertion hole 18a of the case 18, the positive terminal 20 is in contact with a positive electrode of the dry cell 17 located farthest from the battery insertion hole of the case 18 and the negative terminal 21 is in contact with a negative electrode of the dry cell 17 located closest to the battery insertion hole 18a of the case 18. As a result, a DC voltage can be obtained from the positive terminal 20 and the negative terminal 21. The positive terminal 20 and the negative terminal 21 are connected to the anode and cathode of the tubular illuminant 14 through wiring lines (not shown) formed in the case 18 and the cap 19, respectively.

Note that the plurality of dry cells 17 may be connected in parallel, or may be connected in series and in parallel. Further, the dry cells 17 may be housed in the battery box 15 at all times or may be housed in the battery box 15 only when DC direct drive is performed as will be described later.

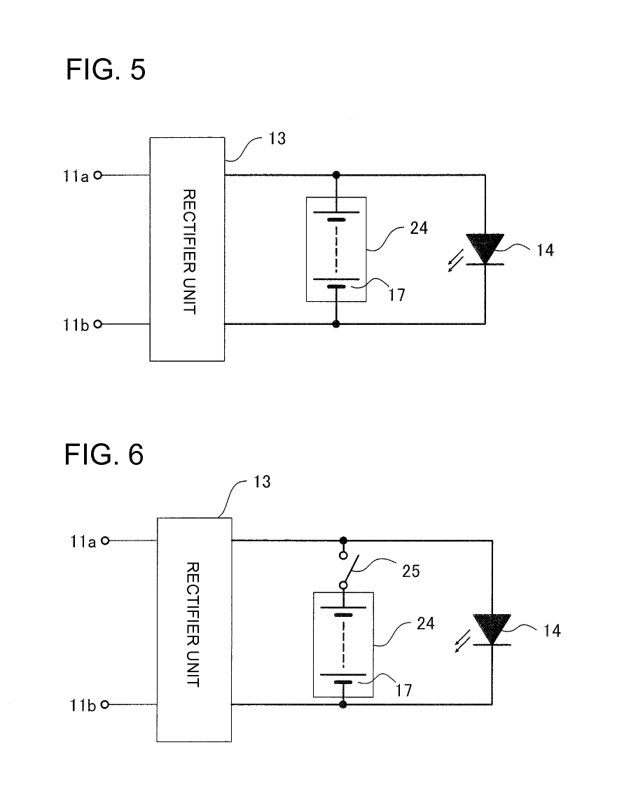

The rectifier unit 13, the tubular illuminant 14, and the dry cells 17 are connected as an electrical circuit as shown in FIG. 5. The plurality of dry cells 17 housed in the battery box 15 serves as a DC power supply 24. Specifically, an AC voltage is supplied to the rectifier unit 13 from the pin terminals 11a and 11b and the DC power supply 24 and the tubular illuminant 14 are connected in parallel between positive and negative output terminals of the rectifier unit 13. In the above-described AC-DC conversion drive, an output voltage of the rectifier unit 13 is applied to the tubular illuminant 14. In the DC direct drive, an output voltage of the DC power supply 24 is applied to the tubular illuminant 14.

A method of using the straight tube light-emitting lamp having such a configuration differs between during the AC-DC conversion drive and during the DC direct drive. In the AC-DC conversion drive, the straight tube light-emitting lamp is used while being attached to the fluorescent lamp lighting apparatus as with the conventional direct tube fluorescent lamp. In order to attach the straight tube light-emitting lamp to the fluorescent lamp lighting apparatus, the pin terminals 11a and 11b and 12a and 12b of the two bases 11 and 12 are inserted into the respective sockets of the fluorescent lamp lighting apparatus. Accordingly, the straight tube light-emitting lamp is supported by the fluorescent lamp lighting apparatus. An AC voltage is supplied to the rectifier unit 13 through the pin terminals 11a and 11b of the base 11 and the AC voltage is converted into a DC voltage by the rectifier unit 13. Since the output DC voltage of the rectifier unit 13 is applied to the tubular illuminant 14, the tubular illuminant 14 is driven to emit light.

The DC direct drive, on the other hand, is typically used when no AC power is supplied due to power outage or the like. The straight tube light-emitting lamp, in particular, may not be attached to the fluorescent lamp lighting apparatus. When no dry cells 17 are installed in the battery box 15, a user removes the base 11, further removes the cap 19, and inserts the plurality of dry cells 17 into the case 18 of the battery box 15. After the dry cells 17 are inserted, the cap 19 and the base 11 are attached in this order. Accordingly, the DC power supply 24 configured of the dry cells 17 and the tubular illuminant 14 are connected with each other. Thus, the output voltage of the DC power supply 24 is applied to the tubular illuminant 14, thereby driving the tubular illuminant 14 to emit light.

As described above, the straight tube light-emitting lamp according to the first embodiment can be used both by means of the AC-DC conversion drive and the DC direct drive. Further, the straight tube light-emitting lamp according to the first embodiment has an advantage such that light emission can be achieved only by the straight tube light-emitting lamp and no DC power supply is externally required in the DC direct drive.

Note that the electrical circuit may be provided with a switch 25 in addition to the rectifier unit 13, the tubular illuminant 14, and the DC power supply 24 as shown in FIG. 6. The switch 25 is provided between a positive electrode of the DC power supply 24 and the tubular illuminant 14. The switch 25 is turned off during the AC-DC conversion drive and turned on during the DC direct drive by a user's operation. The switch 25 may include an operation unit on a surface of the base 11, for example.

The dry cells 17 may be charged by employing rechargeable dry cells as the dry cells 17 and attaching the straight tube light-emitting lamp to the fluorescent lamp lighting apparatus with the dry cells 17 being housed in the battery box 15.

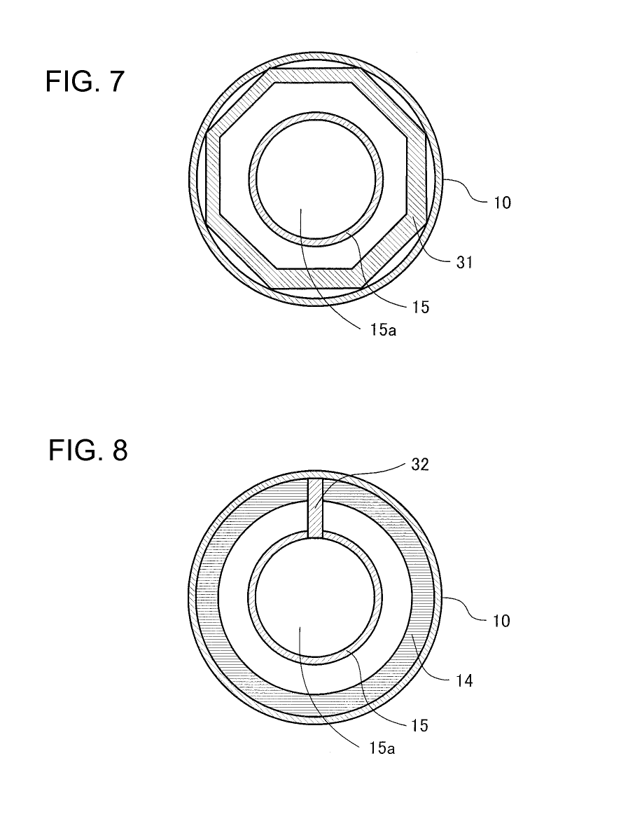

FIG. 7 illustrates a cross section of a straight tube light-emitting lamp according to the second embodiment of the present invention corresponding to the A-A portion in FIG. 1. In the straight tube light-emitting lamp according to the second embodiment, a tubular illuminant 31 in an octagonal pillar shape is disposed along a tube inner wall in the cylindrical transparent glass tube 10. The tubular illuminant 31 has a structure in which an organic EL element is formed on a hard substrate such as a glass substrate having an octagonal pillar shape or a structure formed by disposing eight glass substrates on which organic EL elements are formed so as to make an octagonal pillar shape or a structure formed by bending a resin substrate on which an organic EL element is formed so as to make an octagonal pillar shape. The other structures are the same as those in the straight tube light-emitting lamp according to the first embodiment shown in FIG. 1.

In the case of the straight tube light-emitting lamp according to the second embodiment, the tubular illuminant 31 can be formed hard. For example, a hard substrate can be used as the substrate as described above and a sealing member other than a sealing resin film, such as a glass plate or a metal can, can be used in order to seal the organic EL element. Thus, the reliability of the substrate and the sealing member can be enhanced both. Note that the tubular illuminant 31 is not particularly limited to the octagonal pillar shape. The tubular illuminant 31 may be any shape as long as it has a polygonal pillar shape.

FIG. 8 illustrates a cross section of a straight tube light-emitting lamp according to the third embodiment of the present invention corresponding to the A-A portion in FIG. 1. In the straight tube light-emitting lamp according to the third embodiment, the battery box 15 is joined with the inner wall of the cylindrical transparent glass tube 10 through a connecting member 32. The connecting member 32 protrudes from the inner wall in a radial direction in the circular cross section of the cylindrical transparent glass tube 10. Further, the connecting member 32 is a plate-shaped member extending in the direction connecting between both ends of the cylindrical transparent glass tube 10. The connecting member 32 may be fixed to the cylindrical transparent glass tube 10 and the battery box 15 by adhesion, for example, or may be integrally formed with at least one of the cylindrical transparent glass tube 10 and the battery box 15. Since the tubular illuminant 14 is not disposed on an inner wall portion of the cylindrical transparent glass tube 10 where the connecting member 32 is positioned, that portion becomes a linear non-light-emitting region. However, by configuring the connecting member 32 so as to be positioned on a ceiling side when the straight tube light-emitting lamp according to the third embodiment is attached to the fluorescent lamp lighting apparatus fixed to a ceiling, the straight tube light-emitting lamp according to the third embodiment can be used without being influenced by the non-light-emitting region in terms of its brightness or appearance.

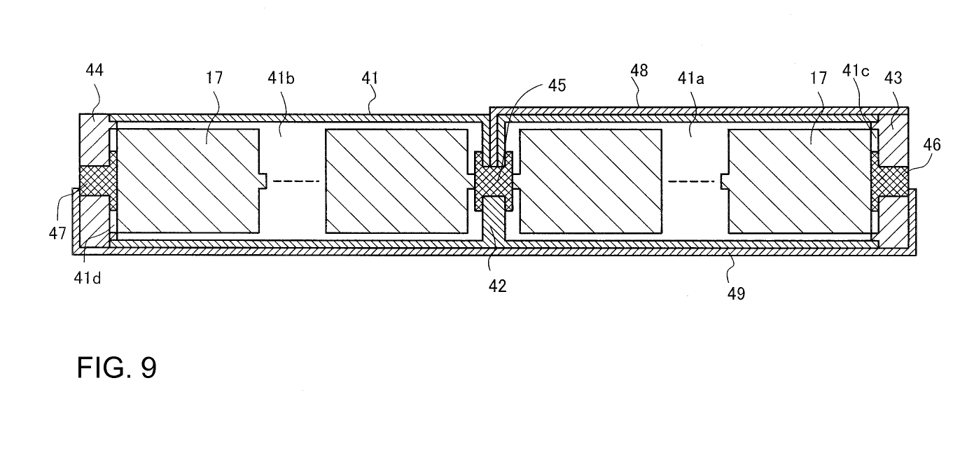

FIG. 9 illustrates a cross section of the battery box 15 inside a straight tube light-emitting lamp according to the fourth embodiment of the present invention. As illustrated in FIG. 9, the battery box 15 in the first embodiment includes a cylindrical case 41 in which a plurality of dry cells 17 are housed separately in two groups. At a center of the case 41, a partition 42 is provided for dividing the inside of the case 41 into two groups of battery housing spaces 41a and 41b each having the same size. The both ends of the case 41 serve as battery insertion holes 41c and 41d. Caps 43 and 44 are detachably attached to the battery insertion holes 41c and 41d, respectively. A positive terminal 45 is fixed to the partition 42 and negative terminals 46 and 47 are fixed to the caps 43 and 44, respectively. The positive terminal 45 is connected to a wiring line 48 formed outside the case 41. The negative terminals 46 and 47 are commonly connected to a wiring line 49 similarly formed outside the case 41. These terminals 45, 46, and 47 and the wiring lines 48 and 49 together form a circuit in which the dry cells 17 are connected in parallel. If the dry cells 17 are inserted into the case 41 from the respective battery insertion holes 41c and 41d at the both ends and the caps 43 and 44 are attached to the case 41 in order to close the battery insertion holes 41c and 41d, the positive terminal 45 is in contact with a positive electrode of the dry cell 17 located farthest from the battery insertion hole in each of the battery housing spaces 41a and 41b and the negative terminals 46 and 47 are in contact with negative electrodes of the dry cells 17 located closest to the battery insertion holes of the case 41, respectively. Thus, a DC voltage between the positive terminal 45 and the negative terminals 46 and 47 can be obtained from the wiring lines 48 and 49.

While ten or more dry cells 17 can be housed in the cylindrical transparent glass tube 10, not all of them need to be connected in series. Since an organic EL element can be generally driven at a relatively low voltage equal to or less than 10 V, a DC drive time can be prolonged by connecting the two groups of dry cells housed in the case 41 in parallel as in the fourth embodiment.

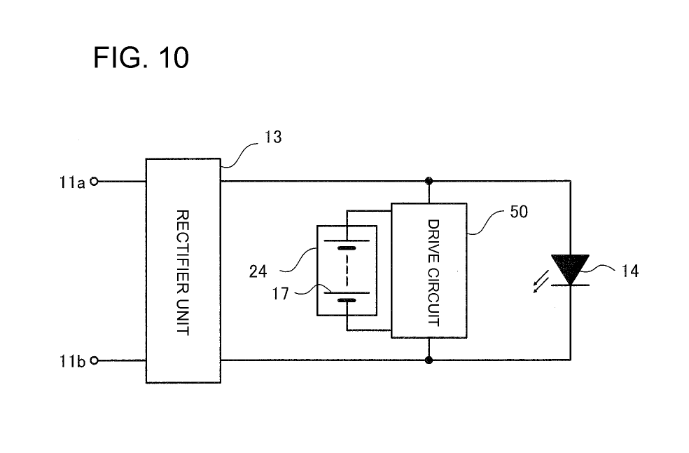

FIG. 10 illustrates an electrical circuit according to the fifth embodiment of the present invention. The electrical circuit in the fifth embodiment is provided with a drive circuit 50 in addition to the rectifier unit 13, the tubular illuminant 14, and the DC power supply 24 in the electrical circuit in the first embodiment. The drive circuit 50 and the tubular illuminant 14 are connected in parallel between positive and negative output terminals of the rectifier unit 13. The DC power supply 24 composed of the plurality of dry cells 17 is connected to the drive circuit 50. When no drive voltage is supplied from the rectifier unit 13, the drive circuit 50 performs a DC drive operation for driving the tubular illuminant 14 according to an output voltage of the DC power supply 24. In the DC direct drive, the drive circuit 50 causes the tubular illuminant 14 to emit light in a mode different from that in the AC-DC conversion drive. For example, the tubular illuminant 14 produces continuous emission during the AC-DC conversion drive, whereas the tubular illuminant 14 produces blinking emission during the DC direct drive.

At the time of a disaster such as an earthquake, power outage may extend over a long period of time or there may be cases where the supply of batteries such as dry cells is difficult. In the fifth embodiment, since the drive circuit 50 for the DC direct drive is provided, the tubular illuminant 14 emits light in a power-saving mode, e.g., with low luminance in order to allow the tubular illuminant 14 to emit light as long as possible with the limited batteries. When this light-emitting lamp is used as an indicator light for indicating one's presence, flash lighting may be employed. Any of such drive methods in the DC direct drive is unnecessary in normal times when an AC power is being supplied. Therefore, the drive circuit 50 is provided between the DC power supply 24 and the tubular illuminant 14. By doing so, unnecessary power consumption of the DC power supply 24 can be suppressed.

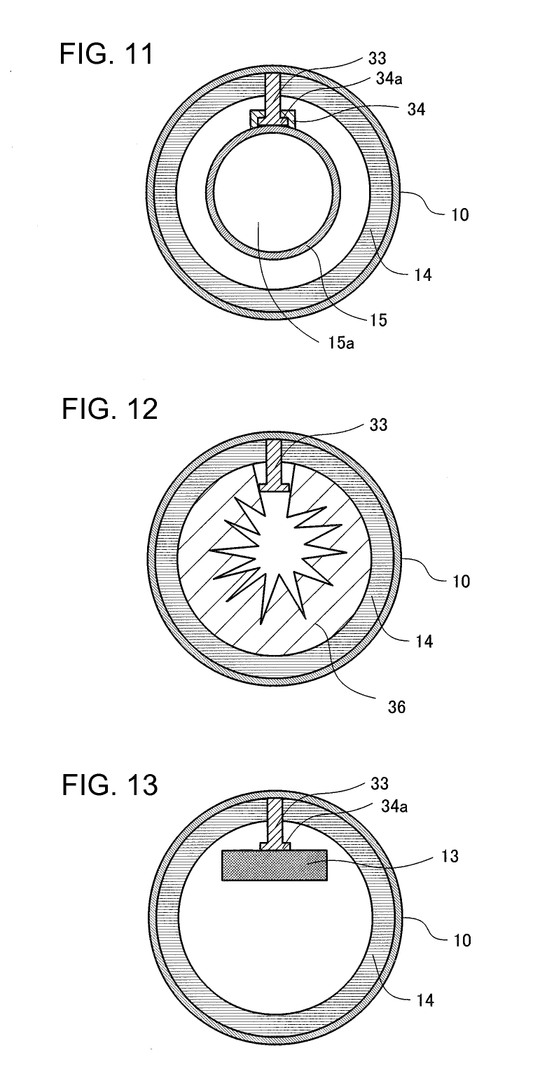

FIG. 11 illustrates a cross section of a straight tube light-emitting lamp according to the sixth embodiment of the present invention corresponding to the A-A portion in FIG. 1. The straight tube light-emitting lamp according to the sixth embodiment is provided with a rail mechanism configured by a rail 33 and an engagement member 34 in order to allow the battery box 15 to be attachable thereto or removable therefrom. The battery box 15 is movable by the rail 33 provided on the inner wall of the cylindrical transparent glass tube 10. The rail 33 is fixed to the inner wall of the cylindrical transparent glass tube 10 and extends in the direction connecting between both ends of the cylindrical transparent glass tube 10. Further, the rail 33 protrudes from the inner wall in a radial direction in the circular cross section of the cylindrical transparent glass tube 10. The protruded tip end portion 34a is formed in a T-letter shape. On an outer wall of the battery box 15 (case 18), on the other hand, the engagement member 34 is fixed. The engagement member 34 is formed in a trough shape (or groove shape) in the longitudinal direction of the case 18. The T-letter-shaped end portion 34a of the rail 33 is positioned inside the trough-shaped engagement member 34 and the engagement member 34 is thereby movable along the rail 33.

As just described, the battery box 15 can be moved along the rail 33 in the direction connecting between both ends of the cylindrical transparent glass tube 10 by the engagement between the rail 33 and the engagement member 34 in the straight tube light-emitting lamp according to the sixth embodiment. Thus, the battery box 15 can be attached to or detached from the main body of the straight tube light-emitting lamp. Specifically, the battery box 15 can be separated from the main body of the straight tube light-emitting lamp. Thus, since the battery box 15 is unnecessary in normal times when the AC-DC conversion drive is performed, the battery box 15 is removed from the main body of the straight tube light-emitting lamp. When it is required to perform the DC direct drive as in the time of power outage, the battery box 15 can be attached to the main body of the straight tube light-emitting lamp and used.

In the straight tube light-emitting lamp according to the sixth embodiment, a spare organic EL element of the tubular illuminant 14 may be housed in a space inside the cylindrical transparent glass tube 10 where the battery box 15 has been removed from the main body of the straight tube light-emitting lamp in normal times when the battery box 15 is not needed. A substrate of the spare organic EL element is made of a flexible material. The spare organic EL element is rolled up and housed in the space inside the cylindrical transparent glass tube 10. When the organic EL element of the tubular illuminant 14 starts to be deteriorated and the luminance thereof is thereby lowered, the deteriorated organic EL element is replaced with the spare organic EL element. In such a configuration, when the straight tube light-emitting lamp is used by means of the DC direct drive, the spare organic EL element is removed from the space inside the cylindrical transparent glass tube 10 and the battery box 15 is attached to the main body of the straight tube light-emitting lamp as described above instead.

Further, in the straight tube light-emitting lamp according to the sixth embodiment, a heat sink 36 may be disposed as illustrated in FIG. 12 in place of the battery box 15 in the space inside the cylindrical transparent glass tube 10 where the battery box 15 has been removed from the main body of the straight tube light-emitting lamp in normal times when the battery box 15 is not needed. The heat sink 36 is disposed at an inner side than the tubular illuminant 14 in the cylindrical transparent glass tube 10 so as to be in contact with the tubular illuminant 14. Further, the heat sink 36 is configured to be removable. A through hole or a slit for releasing heat may be provided in the cylindrical transparent glass tube 10. In such a configuration, when the straight tube light-emitting lamp is used by means of the DC direct drive, the heat sink 36 is removed from the space inside the cylindrical transparent glass tube 10 and the battery box 15 is attached to the main body of the straight tube light-emitting lamp as described above instead.

Further, in the straight tube light-emitting lamp according to the sixth embodiment, the rectifier unit 13 may be disposed as illustrated in FIG. 13 in place of the battery box 15 in the space inside the cylindrical transparent glass tube 10 where the battery box 15 has been removed from the main body of the straight tube light-emitting lamp in normal times when the battery box 15 is not needed. The rectifier unit 13 is detachably attached to the end portion of the rail 33. The attached state corresponds to the time of the AC-DC conversion drive and the rectifier unit 13 is electrically connected to the tubular illuminant 14. On the other hand, the rectifier unit 13 which is unnecessary when the straight tube light-emitting lamp is used by means of the DC direct drive is removed from the space inside the cylindrical transparent glass tube 10 and the battery box 15 is attached to the main body of the straight tube light-emitting lamp instead. With such a configuration, a rectifier unit having a substrate larger than that in the first embodiment can be employed as the rectifier unit 13. Thus, this is advantageous in terms of circuit design of the rectifier unit 13.

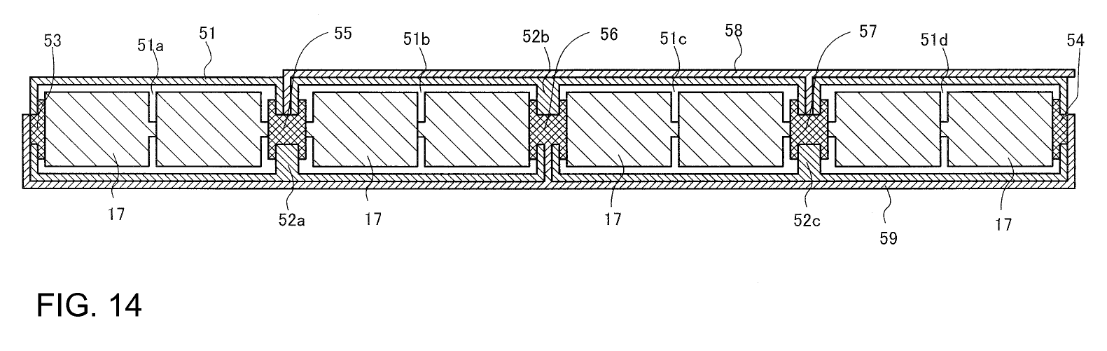

Further, in the straight tube light-emitting lamp according to the first embodiment, the dry cells 17 need to be inserted into the battery box 15 fixed in the cylindrical transparent glass tube 10 after the base 12 is removed. In the straight tube light-emitting lamp according to the sixth embodiment, however, since the battery box 15 itself can be removed from the main body of the straight tube light-emitting lamp, there is no need to configure the battery box 15 so as to house the dry cells 17 in the longitudinal cylindrical case 18. In the sixth embodiment, the battery box 15 may have any configuration as long as each of the plurality of dry cells 17 is fixed. The battery box 15 may be configured such that each of the dry cells 17 can be directly attached to a predetermined fixed position or removed from the fixed position. Therefore, in the sixth embodiment, the battery box 15 may be configured such that eight dry cells 17 are housed separately in four groups, for example, as illustrated in FIG. 14. In the battery box 15 illustrated in FIG. 14, a longitudinal frame member 51 is divided into four groups of battery housing spaces 51a to 51d, each having the same size, by three partitions 52a to 52c. The frame member 51 is configured such that the dry cell 17 can be attached thereto or removed therefrom individually in each of the battery housing spaces 51a to 51d. The frame member 51 is configured so as to surround only a portion of a side surface of each of the dry cells 17. In each of the battery housing spaces 51a to 51d, two dry cells are disposed in series connection. Negative terminals 53 and 54 are disposed at both ends of the frame member 51 in the longitudinal direction thereof. At the partitions 52a to 52c, a positive terminal 55, a negative terminal 56, and a positive terminal 57 are disposed, respectively. The positive terminals 55 and 57 are commonly connected to a wiring line 58 formed outside the frame member 51. The negative terminals 53, 54, and 56 are commonly connected to a wiring line 59 similarly formed outside the frame member 51. Accordingly, four sets of two dry cells 17 connected in series are being connected in parallel. As long as a voltage capable of driving the tubular illuminant 14 can be obtained, by increasing the number of the parallel-connected sets, longer driving can be achieved.

### REFERENCE NUMERALS

10 Cylindrical transparent glass tube
11, 12 Base
13 Rectifier unit
14 Tubular illuminant
15 Battery box
17 Dry cell
24 DC power supply
33 Rail

1. A lamp comprising:
a transparent tube;
an tubular organic electroluminescence (EL) illuminant disposed inside the transparent tube so as to surround a center axis of the transparent tube;
a battery box configured to house a battery disposed within an inner circumference of the tubular illuminant; and
a wiring circuit for supplying an output voltage of the battery housed in the battery box to the tubular illuminant.

2. The lamp according to claim 1, further comprising
bases disposed at opposite ends of the transparent tube so as to cover openings at the ends of the transparent tube,
wherein the bases are configured to couple to external sockets, and
at least one of the bases is removably engaged with its respective opening.

3. The lamp according to claim 2, further comprising a rectifier unit disposed within at least one of the bases, the rectifier unit configured to rectify AC voltage supplied through at least one of the external sockets and output a DC voltage to the tubular illuminant through the wiring circuit.

4. The lamp according to claim 3, wherein the wiring circuit supplies the output voltage of the battery to the tubular illuminant when the AC voltage is not supplied to the at least one of the bases.

5. The lamp according to claim 3, further comprising a drive circuit configured to drive the tubular illuminant with the output voltage of the battery when the DC voltage is not being supplied from the rectifier unit,
wherein the drive circuit is configured to drive the tubular illuminant to emit light in a mode different than a mode of light emitted by the tubular illuminant when the DC voltage is being supplied from the rectifier unit.

6. The lamp according to claim 1, wherein a transverse cross-section of the tubular illuminant is one of circular and polygonal.

7. The lamp according to claim 1, wherein the battery box is removably attached to the transparent tube.

8. The lamp according to claim 7, further comprising a heat sink disposed within the inner circumference of the tubular illuminant in place of the battery box.

9. The lamp according to claim 7, further comprising a rectifier unit disposed within the inner circumference of the tubular illuminant in place of the battery box.

10. A tube lamp comprising:
an illuminant disposed inside a transparent tube;
a direct current power supply inside the transparent tube and coupled to the illuminant; and
a rectifier unit inside the transparent tube and coupled to the direct current power supply, wherein the direct current power supply generates a voltage that drives the illuminant.

11. The tube lamp according to claim 10, further comprising a switch provided between the illuminant and the direct current power supply, the switch configured to receive an input from a user.

12. The tube lamp according to claim 10, further comprising a drive circuit coupled between a first terminal and a second terminal of the rectifier, and coupled to the direct current power supply, wherein the drive circuit performs a DC drive operation for driving the illuminant according to an output voltage of the direct current power supply when no drive voltage is supplied from the rectifier.

13. A lamp, comprising:
a transparent tube;
a solid-state light source disposed within the transparent tube;
a power supply configured to supply power to the solid-state light source.

14. The lamp according to claim 13, wherein the transparent tube comprises a straight tube.

15. The lamp according to claim 13, wherein the solid-state light source comprises an organic electroluminescent element.

16. The lamp according to claim 13, wherein the power supply comprises a rectifier unit configured to rectify AC voltage supplied to the lamp and output DC voltage to the solid-state light source.

17. The lamp according to claim 16, wherein the power supply further comprises at least one battery configured to supply DC voltage to the solid-state light source.

18. The lamp according to claim 17, wherein the power supply further comprises a switch connected between the at least one battery and the solid-state light source,
wherein in a first position the switch is configured to disconnect the at least one battery from the solid-state light source, and
in a second position the switch is configured to connect the at least one battery to the solid-state light source.
